(19) United States
(12) Patent Application Publication
(10) Pub. No.: US 2015/0264958 A1
(43) Pub. Date: Sep. 24, 2015

(54) CHEWING GUM PRODUCT AND METHOD FOR THE FORMATION THEREOF

(71) Applicant: INTERCONTINENTAL GREAT BRANDS LLC, East Hanover, NJ (US)

(72) Inventors: Kishor Kabse, Morris Plains, NJ (US); Clive Richard Norton, Chatham, NJ (US); Bary L. Zeller, Glenview, IL (US); Cesar Carlos Elejalde, Randolph, NJ (US); Yoshimitsu Kamakura, Kanagawa (JP); Atsushi Ueminami, Atsushi (JP)

(73) Assignee: Intercontinental Great Brands LLC, East Hanover, NJ (US)

(21) Appl. No.: 14/434,847

(22) PCT Filed: Oct. 8, 2013
(86) PCT No.: PCT/US2013/063788

§ 371 Date: Apr. 10, 2015

Related U.S. Application Data
(60) Provisional application No. 61/715,332, filed on Oct. 18, 2012.

(51) Int. Cl. A23G 4/20; A23G 4/06

(52) U.S. Cl. CPC A23G 4/205; A23G 4/06; A23V 2002/00

(57) ABSTRACT

A chewing gum product is formed by a method that includes extruding a chewing gum material to form an extruded body portion with capillaries, adding a fill material to at least one capillary to form a filled extruded body, and separating the filled extruded body to form the chewing gum product. The fill material includes about 20 to about 80 weight percent sorbitol, and about 20 to about 80 weight percent xylitol, wherein the total of sorbitol and xylitol is at least 80 weight percent. On cooling, the fill material crystallizes to form a crunchy filling.

### BACKGROUND OF THE INVENTION

It is desirable to produce confectionery products formed of different components, so as to increase sensory pleasure. A number of existing confectionery products have multiple regions formed of different components. For example, multi-layer confectionery products can include multiple layers of different confectionery components stacked one above another. Center-filled confectionery compositions are also known that comprise a core (or center-fill) confectionery component and a shell confectionery component surrounding the core component. Also known are coated confectionery compositions, which comprise a coating of one confectionery component over another confectionery component. The presence of different components increases sensory pleasure by providing a variety of flavors and textures to a consumer.

International Publication No. WO 2007/056685 A2 of Fornaguera discloses a method and apparatus for producing a plurality of center-filled ropes, where the rope material can be a chewing gum material. The ropes are subsequently separated and crimped to form individual pieces in which the centerfill material is sealed within each piece. International Publication No. WO 2010/034977 A1 of Vaman et al. discloses a chewing gum product that includes a chewing gum material in the form of an extruded body portion having a plurality of capillaries disposed therein. When making chewing gum products that include a plurality of filled capillaries, a number of challenges are encountered. For example, the fill material should be added to the capillaries at a temperature less than or equal to 80° C. to be compatible with the extruded chewing gum material. The capillary fill material should also have a low enough viscosity for pumping during the addition process, but a high enough viscosity to prevent leakage when the extruded confection is cut to expose the open ends of capillaries. One approach to avoiding leakage is to incorporate into the fill material a thickening agent, such as carboxymethylcellulose or pectin. However, the attendant increase in fill material viscosity can interfere with addition of the fill material through the small diameter orifices needed to fill capillaries. When a chewing gum product having a crunchy fill material is desired, then a crystallizable fill material is useful, but a thickening agent can interfere with the rate and extent of fill material crystallization. Accordingly, there remains a need for chewing gum products having capillaries filled with materials that are easily added to a capillary within a chewing gum material but harden to a crunchy material and avoid leakage during cutting and packaging.

### BRIEF SUMMARY OF EMBODIMENTS OF THE INVENTION

One embodiment is a method of forming a chewing gum product, the method comprising: extruding a chewing gum material to form an extruded body portion and a plurality of capillaries disposed in the extruded body portion; adding a fill material to at least one capillary to form a filled extruded body; and separating the filled extruded body to form the chewing gum product; wherein the fill material comprises, based on the total weight of the fill material, about 20 to about 80 weight percent sorbitol, and about 20 to about 80 weight percent xylitol; wherein the total of sorbitol and xylitol is at least 80 weight percent.

Another embodiment is a chewing gum product prepared by the method.

Another embodiment is a chewing gum product, comprising: an extruded body portion comprising a chewing gum material; and a plurality of capillaries disposed in the extruded body portion, at least one of the capillaries comprising a fill material comprising, based on the total weight of the fill material, about 20 to about 80 weight percent sorbitol, and about 20 to about 80 weight percent xylitol; wherein the total of sorbitol and xylitol is at least 80 weight percent, based on the total weight of the fill material.

### BRIEF DESCRIPTION OF THE DRAWINGS

In the following drawings, like elements are numbered alike.

FIG. 1 is a schematic diagram illustrating the apparatus used for preparing various examples of chewing gum products.

FIG. 2 is a schematic diagram illustrating the extrusion die assembly used together with the apparatus of FIG. 1 for preparing various chewing gum products.

FIG. 3 is a schematic diagram of a microcapillary die used for preparing various chewing gum products.

FIG. 4 shows a perspective view of an embodiment of a chewing gum product as described herein, having an extruded body portion comprising chewing gum material and three capillaries with fill material.

### DETAILED DESCRIPTION OF THE INVENTION

The present inventors have determined that a chewing gum product with filled capillaries is readily formed but avoids leakage during cutting and packaging and hardens to a crunchy material when the fill material comprises about 20 to about 80 weight percent sorbitol, and about 20 to about 80 weight percent xylitol, wherein the total of sorbitol and xylitol is at least 80 weight percent, based on the total weight of fill material.

One embodiment is a method of forming a chewing gum product, the method comprising: extruding a chewing gum material to form an extruded body portion and a plurality of capillaries disposed in the extruded body portion; adding a fill material to at least one capillary to form a filled extruded body; and separating the filled extruded body to form the chewing gum product; wherein the fill material comprises, based on the total weight of the fill material, about 20 to about 80 weight percent sorbitol, and about 20 to about 80 weight percent xylitol; wherein the total of sorbitol and xylitol is at least 80 weight percent.

The fill material is composed primarily of sorbitol and xylitol. Specifically, sorbitol and xylitol collective make up at least 80 weight percent of the fill material. The total amount of sorbitol and xylitol can be at least 85 weight percent, at least 90 weight percent, or at least 95 weight percent, based on the total weight of the fill material.

The weight ratio of sorbitol to xylitol in the fill material can be about 20:80 to about 80:20. In some embodiments, the fill material comprises the sorbitol and xylitol in a weight ratio of about 20:80 to about 50:50, specifically about 20:80 to about 40:60. In other embodiments, the fill material comprises the sorbitol and xylitol in a weight ratio of about 60:40 to about 80:20, specifically about 70:30 to about 80:20.

The fill material can be prepared, in part, by melting a mixture of sorbitol and xylitol to form a homogeneous liquid (molten) mixture. Alternatively, the sorbitol and xylitol can be separately melted and then combined to form a homogeneous mixture. Although it is possible to utilize water or another solvent to facilitate liquefying the sorbitol/xylitol mixture, such solvent use is preferably avoided in order to eliminate the need for a subsequent solvent removal step. Moreover, the presence of a substantial amount of solvent can interfere with subsequent crystallization of the fill material. In some embodiments, the fill material comprises less than or equal to 5 weight percent water, specifically less than or equal to 4 weight percent water, based on the total weight of fill material. It will be understood that in this context “water” includes all forms of water, and not just water intentionally added to the fill material. For example, water present as an impurity in the sorbitol and/or xylitol is included. Because of the equilibrium water contents of sorbitol and xylitol under ambient conditions, it can be challenging to maintain a water content much lower than a few weight percent. In some embodiments, the method comprises forming the fill material prior to said adding the fill material to at least one capillary. In these embodiments, forming the fill material comprises blending about 1 to about 20 weight percent crystalline sorbitol and/or xylitol, and about 80 to about 99 weight percent liquid sorbitol and xylitol, based on the total weight of the fill material.

One advantage of the fill material is that it avoids the need for a thickening agent. Specifically, only moderate and brief cooling of the filled extruded body is needed to harden the fill material sufficiently to reduce or eliminate leakage during the subsequent separating step. So, it is possible to reduce or eliminate the use of thickening agents in the fill material. For example, the fill material can comprise less than or equal to 0.1 weight percent thickening agent, specifically less than or equal to 0.05 weight percent thickening agent, more specifically less than or equal to 0.01 weight percent thickening agent, based on the total weight of fill material. In some embodiments, the fill material excludes thickening agents. The thickening agents to be reduced or eliminated include, for example, pectin, gum arabic, acacia gum, alginates, agar, carrageenan, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, bacterial gums, starch, cellulose, carboxymethylcellulose, methylcellulose, hydroxypropylmethylcellulose, hydroxypropylcellulose, and combinations thereof.

In some embodiments, the fill material during the addition to at least one capillary comprises, based on the total weight of the fill material, about 1 to about 20 weight percent crystalline sorbitol and/or xylitol, and about 80 to about 99 weight percent liquid (molten) sorbitol and xylitol. Note that the liquid necessarily includes both sorbitol and xylitol in order to benefit from the reduced melting points associated with their mixtures. The crystalline sorbitol and/or xylitol facilitates or “seeds” the crystallization of the liquid (molten) sorbitol and xylitol. When present, the amount of the crystalline sorbitol and/or xylitol can be about 1 to about 20 weight percent, based on the total weight of the fill material. Within this range, the amount of the crystalline sorbitol and/or xylitol can be about 2 to about 18 weight percent, specifically about 4 to about 16 weight percent, more specifically about 5 to about 15 weight percent. When crystalline sorbitol and/or xylitol is included in the fill material, the amount of the liquid (molten) sorbitol and xylitol can be about 80 to about 99 weight percent, based on the total weight of the fill material. Within this range, the amount of the liquid (molten) sorbitol and xylitol can be about 82 to about 98 weight percent, specifically about 84 to about 96 weight percent, more specifically about 85 to about 95 weight percent.

The crystalline sorbitol and/or xylitol can be crystalline sorbitol, crystalline xylitol, a co-crystalline sorbitol/xylitol blend, or a combination of at least two of the foregoing. The composition of the crystalline sorbitol and/or xylitol can range from pure sorbitol to pure xylitol and encompasses sorbitol/xylitol blends in any weight ratio. In some embodiments, the crystalline sorbitol and/or xylitol comprises about 10 to about 90 weight percent crystalline sorbitol and about 10 to about 90 weight percent crystalline xylitol, based on the total weight of crystalline sorbitol and/or xylitol. In some embodiments, the crystalline sorbitol and/or xylitol comprises about 20 to about 40 weight percent crystalline sorbitol and about 60 to about 80 weight percent crystalline xylitol, based on the total weight of crystalline sorbitol and/or xylitol. In other embodiments, the crystalline sorbitol and/or xylitol comprises about 70 to about 80 weight percent crystalline sorbitol and about 20 to about 30 weight percent crystalline xylitol. As noted above, the specified amounts of crystalline sorbitol and crystalline xylitol can include contributions from cocrystallized sorbitol and xylitol. The particle size of the crystalline sorbitol and/or xylitol is not critical as long as it is smaller than the diameter of the capillary into which the fill material is added. In some embodiments, the crystalline sorbitol and/or xylitol has a particle size mean diameter of about 25 to about 500 micrometers, specifically about 35 to about 400 micrometers, more specifically about 50 to about 300 micrometers. Particle size mean diameter can be determined by those skilled in the art. Suitable particle size determination techniques include, for example, sieving, microscopic analysis, and dynamic light scattering. In some embodiments, the crystalline sorbitol and/or xylitol comprises less than 10 number percent, specifically less than 5 number percent, of particles having a diameter less than 25 micrometers, and less than 10 number percent, specifically less than 5 number percent, of particles having a diameter greater than 500 micrometers.

The fill material is added to at least one capillary to form a filled extruded body. In this context the word “added” includes pumping the fill material, extruding the fill material, and other means of forcing the fill material into the at least one capillary. At the time at which it is added to a capillary, the fill material comprises liquid (molten) sorbitol and xylitol. The composition of the liquid (molten) sorbitol and xylitol is any composition that, accounting for the composition of the optional crystalline sorbitol and/or xylitol, provides a total fill material composition of about 20 to about 80 weight percent sorbitol, and about 20 to about 80 weight percent xylitol, wherein the total of sorbitol and xylitol is at least 80 weight percent, based on the total weight of fill material. In some embodiments, the liquid (molten) sorbitol and xylitol comprises about 20 to about 80 weight percent sorbitol, and about 20 to about 80 weight percent xylitol, based on the total weight of the liquid (molten) sorbitol and xylitol. In some embodiments, the liquid (molten) sorbitol and xylitol comprises about 20 to about 40 weight percent sorbitol and about 60 to about 80 weight percent xylitol, based on the total weight of liquid (molten) sorbitol and xylitol. In some embodiments, the liquid (molten) sorbitol and xylitol comprises about 70 to about 80 weight percent sorbitol and about 20 to about 30 weight percent xylitol, based on the total weight of liquid (molten) sorbitol and xylitol.

In addition to the sorbitol and xylitol, the fill material can, optionally, further comprise up to 20 weight percent of other components. Such additional components can include, for example, sweetening agents other than the xylitol and sorbitol (including high-intensity sweeteners), sweetener modulators and potentiators, flavoring agents, flavor modulators and potentiators, aroma agents, cooling agents, warming agents, tingling agents, colorants (including dyes and pigments), breath fresheners, oral care agents, throat care agents, medicaments, mouth moisteners, humectants, acidulants, buffering agents, antioxidants, preservatives, and combinations thereof. These additional components are described in detail below. In some embodiments, such confectionery additives are used in an amount of less than or equal to 10 weight percent, specifically less than or equal to 5 weight percent, based on the total weight of the fill material. In some embodiments, the fill material excludes confectionery additives. In some embodiments, the fill material comprises one or more flavoring agents in an amount of 0.05 to about 10 weight percent, specifically about 0.1 to about 5 weight percent, more specifically about 0.2 to about 2 weight percent, even more specifically about 0.3 to about 1 weight percent, based on the total weight of the fill material. In some embodiments, the fill material consists of xylitol, sorbitol, and, optionally, one or more flavoring agents and/or coloring agents. In some embodiments, the fill material consists of xylitol and sorbitol.

One advantage of the fill material is that it can be added to a capillary at a low temperature relative to the higher melting points characteristic of the separate sorbitol and xylitol components used to prepare the fill material. The fill material addition temperature is compatible with simultaneous extrusion of chewing gum material and addition of fill material to a capillary. For example, the fill material can be added to a capillary at a temperature of about 60 to about 80° C., specifically about 65 to about 75° C., more specifically about 70 to about 75° C. The chewing gum material can be extruded at a temperature of about 30 to about 50° C., specifically about 35 to about 45° C.

In some embodiments, the viscosity of the gum material at its extrusion temperature (e.g., its temperature at the die) is greater than the viscosity of the fill material at its addition temperature (e.g., its temperature at the die).

Another advantage of the fill material is that it hardens rapidly on cooling. As noted above, only moderate and brief cooling of the filled extruded body is needed to harden the fill material sufficiently to reduce or eliminate leakage during the subsequent separating step, and any wrapping step. For example, the filled extruded body can be air-cooled for about 60 to about 300 seconds at a temperature of about −10 to about 10° C.

After its formation, the filled extruded body can be further sized, for example by stretching, or shaped, for example by folding.

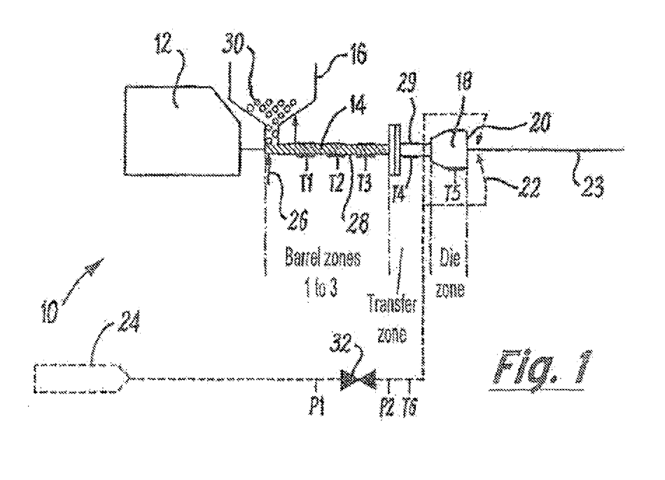

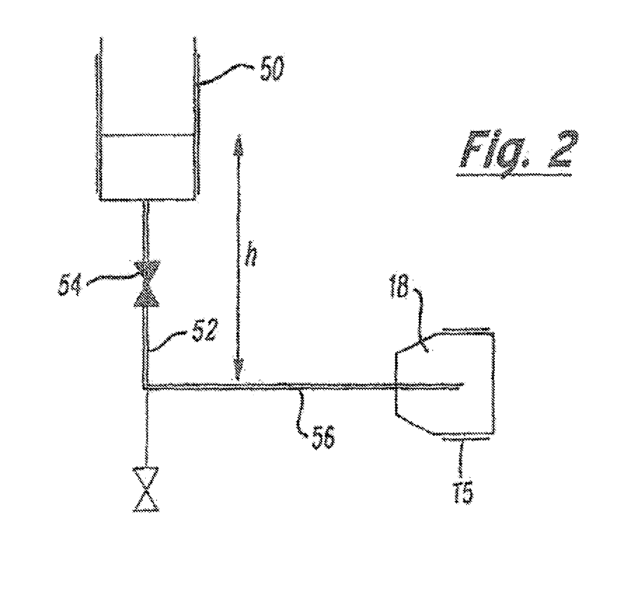

Chewing gum products can be prepared by simultaneous extrusion of chewing gum material and addition of fill material to at least one capillary. The extrusion equipment can be, for example, a Davis-Standard single screw extruder, with a screw diameter of 19 millimeters, and a screw length to diameter ratio of 24:1. In some embodiments, the extruder has multiple temperature zones. In a specific embodiment, the extruder has four different temperature zones (denoted T1-T4 in FIG. 1), each of which can be independently controlled using proportional integral derivative controllers connected to band heaters. An extrusion die, containing an entrainment array consisting of 3 needles, is connected on the extruder endplate. Two opposed air jets, used to rapidly cool the extrudate emerging from the extrusion die, are placed above and below the die exit; these jets are connected via a valve to a compressed air line at 7×10⁵ Newton per square meters. A schematic diagram showing the general layout of the extrusion line is shown in FIG. 1 and a schematic drawing of the capillary die is shown in FIG. 2.

With reference to FIG. 1, there is shown a schematic diagram of the extrusion apparatus 10 used in the experiments. The apparatus comprises an electric motor 12 which is rotatably coupled to an extrusion screw 14. The screw 14 is fed at one end by a hopper 16 and the opposing end is coupled to an extrusion die 18 having an extrudate outlet 20. Quench jets 22 are directed toward the die outlet 20 so as to cool the extruded material 23, and these jets are fed with compressed air 24. If desired, the area of the apparatus where the hopper 16 is coupled to the screw 14 can be cooled by means of a cooling feed 26. Surrounding the screw 14 is a barrel 28, which has three barrel temperature zones denoted T1 to T3—the temperatures of each zone can be controlled independent of other zones. The barrel 28 is connected to the die 18 by means of a feed conduit 29 which has a temperature zone T4 which can be controlled. In use, the hopper 16 is filled with chewing gum material 30 which can be heated so as to maintain it in a flowable form. Before the chewing gum material passes into the screw 14, it can be cooled by means of the cool feed 26, so as to ensure that the material is at the correct temperature for entering the screw extruder. As the screw is rotated, the liquid material is drawn along the screw 14, inside the barrel 28 and the temperature of the zones T1-T3 adjusted accordingly. The material then passes through the feed conduit 29 and the temperature adjusted again (if required) by temperature control T4 before entering the die 18.

With reference to FIG. 2, there is shown a schematic diagram of the extrusion die assembly used together with the apparatus of FIG. 1 for preparing various chewing gum products. Reservoir 50 holds the fill material. The reservoir 50 is heated so that the fill material is maintained at correct temperature so as to maintain it in liquid state. The reservoir 50 is connected to a conduit 52 having an isolation valve 54 for controlling the flow of liquid. The conduit 52 is encased in a trace heating tube 56 which maintains the temperature of the conduit so that the liquid remains in a liquid state during its movement within the conduit. The conduit 52 is coupled to the inlet to the die 18 having a number of needles, so that when the chewing gum material is being extruded, the capillaries formed around the needles can be simultaneously filled with the fill material.

FIG. 3 shows the die 18 in more detail. In particular, this figure shows that the metallic die 18 has, at one end, a plurality of needles 60 which are joined to a cavity 62 which is in fluid communication with an inlet channel 64 for pumping a fill material into the needles 60. While the chewing gum material is being extruded, the fill material is added (e.g., pumped or extruded) through the needles so that the extrudate contains a number of capillaries filled with the fill material. Referring again to FIG. 1, the extrudate 23 is cooled by means of the quench jets 22 as it is released from the die 18.

The chewing gum material and the fill material are typically used in proportions such that the extruded gum material is a major portion of the chewing gum product, and the fill material is a minor portion of the chewing gum product. For example, the chewing gum product can comprise about 60 to about 90 weight percent of the chewing gum material, and about 10 to about 40 weight percent of the fill material, based on the total weight of the chewing gum product. Within the range of about 60 to about 90 weight percent, the chewing gum material amount can be about 70 to about 85 weight percent, specifically about 75 to about 85 weight percent. Within the range of about 10 to about 40 weight percent, the fill material amount can be about 15 to about 30 weight percent, specifically about 15 to about 25 weight percent.

Another advantage of the fill material is that it provides a pleasing crunchiness when the chewing gum product is consumed. While not wishing to be bound by any particular theory of operation, the inventors believe that the crunchiness is provided by crystals formed when the fill material crystallizes with cooling, which can be accomplished in seconds, and aging on the timescale of minutes, hours, or days. Note that crystallization of the fill material can continue after the initial hardening that accompanies cooling. In some embodiments, the crystallized fill material comprises crystals having at least one dimension of at least 20 micrometers, specifically 20 to about 2,000 micrometers, more specifically about 25 to about 1,000 micrometers, still more specifically about 25 to about 250 micrometers, even more specifically about 50 to about 200 micrometers.

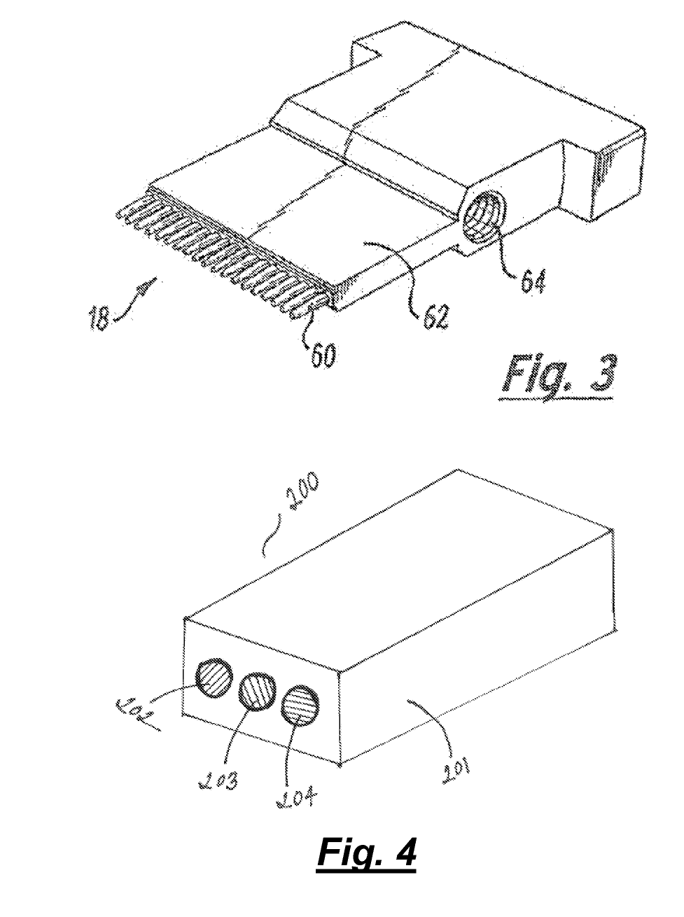

The method includes separating the filled extruded body to form the chewing gum product. As used herein, the term “separating” includes cutting, slicing, cleaving, and other means of dividing the filled extruded body into chewing gum pieces. In some embodiments, the chewing gum piece approximates the shape of a rectangular prism having a length of about 20 to about 50 millimeters, a width of about 6 to about 20 millimeters, and a thickness of about 2 to about 8 millimeters. The method can, optionally, further include wrapping the chewing gum product. FIG. 4 shows a rectangular prism chewing gum product 200 having an extruded body 201 with a rectangular cross-section. Within the extruded body 201 is a plurality of (in this case, three) capillaries 202, 203, and 204 filled with fill material. In some embodiments, at least two of the capillaries contain different fill materials. The fill materials differ in at least one aspect of their composition, such as, for example, their sorbitol amount, xylitol amount, color, or flavoring. In such embodiments, the different fill materials are delivered via different extrusion die assemblies of the type shown in FIG. 2.

In a very specific embodiment of the method of forming a chewing gum product, the fill material comprises less than or equal to 5 weight percent water, based on the total weight of fill material; the fill material comprises less than or equal to 0.05 weight percent thickening agent, based on the total weight of fill material; the fill material comprises the sorbitol and xylitol in a weight ratio of about 20:80 to about 40:60; the total of sorbitol and xylitol in the fill material is at least 90 weight percent; the adding a fill material to at least one capillary comprises adding the fill material at a temperature of about 60 to about 80° C.; and the chewing gum product comprises about 60 to about 90 weight percent of the chewing gum material, and about 10 to about 40 weight percent of the fill material. In some embodiments, the fill material during the addition to at least one capillary comprises, based on the total weight of the fill material, about 1 to about 20 weight percent crystalline sorbitol and/or xylitol, and about 80 to about 99 weight percent liquid sorbitol and xylitol.

Another embodiment is a method of forming a chewing gum product, the method comprising: forming a fill material comprising, based on the total weight of the fill material, about 20 to about 80 weight percent sorbitol, and about 20 to about 80 weight percent xylitol, wherein the total of sorbitol and xylitol is at least 80 weight percent; wherein the fill material comprises, based on the total weight of the fill material, about 1 to about 20 weight percent crystalline sorbitol and/or xylitol, and about 80 to about 99 weight percent liquid sorbitol and xylitol; extruding a chewing gum material to form an extruded body portion and a plurality of capillaries disposed in the extruded body portion; adding the fill material to at least one capillary to form a filled extruded body; and separating the filled extruded body to form the chewing gum product.

The invention includes a chewing gum product prepared by any of the above-described variations of the method.

Another embodiment is a chewing gum product, comprising: an extruded body portion comprising a chewing gum material, and a plurality of capillaries disposed in the extruded body portion, at least one of the capillaries comprising a fill material comprising, based on the total weight of the fill material, about 20 to about 80 weight percent sorbitol, and about 20 to about 80 weight percent xylitol; wherein the total of sorbitol and xylitol is at least 80 weight percent, based on the total weight of the fill material.

The compositional variations described above in the context of the method apply as well to the chewing gum product. For example, the total of sorbitol and xylitol in the fill material can be at least 85, at least 90, or at least 95 weight percent, based on the total weight of the fill material. As another example, the fill material can comprise less than or equal to 5 weight percent water, specifically less than or equal to 4 weight percent water, based on the total weight of fill material. As another example, the fill material can comprises less than or equal to 0.1 weight percent thickening agent, specifically less than or equal to 0.05 weight percent thickening agent, more specifically less than or equal to 0.01 weight percent thickening agent, based on the total weight of fill material. Or the fill material can exclude thickening agents. As another example, the fill material can comprise the sorbitol and xylitol in a weight ratio of about 20:80 to about 40:60. As another example, the total of sorbitol and xylitol in the fill material can be at least 90 weight percent, based on the total weight of the fill material. As another example, the chewing gum product can comprise the chewing gum material in an amount about 60 to about 90 weight percent, specifically about 70 to about 85 weight percent, more specifically about 75 to about 85 weight percent; and it can comprise the fill material in an amount of about 10 to about 40 weight percent, specifically about 15 to about 30 weight percent, more specifically about 15 to about 25 weight percent, based on the total weight of the chewing gum product.

The fill material can, optionally, further comprise glycerol, propylene glycol, or a combination thereof. Among their other functions, these compounds can depress the melting point of the fill material. In some embodiments, glycerol alone is employed. When present, the glycerol, propylene glycol, or combination thereof can be used in an amount of about 0.5 to 10 weight percent, specifically about 1 to about 5 weight percent, based on the total weight of the fill material. In some embodiments, the fill material excludes glycerol and propylene glycol.

In a very specific embodiment of the chewing gum product, the fill material comprises less than or equal to 5 weight percent water, based on the total weight of fill material; the fill material comprises less than or equal to 0.05 weight percent thickening agent, based on the total weight of fill material; the fill material comprises the sorbitol and xylitol in a weight ratio of about 20:80 to about 40:60; the total of sorbitol and xylitol in the fill material is at least 90 weight percent; and the chewing gum product comprises about 60 to about 90 weight percent of the chewing gum material, and about 10 to about 40 weight percent of the fill material.

In some embodiments, the chewing gum product comprises a first capillary comprising a first fill material (which is the “fill material” described in the embodiments above), and a second capillary comprising a second fill material different from the first fill material. The fill materials differ in at least one aspect of their composition, such as, for example, their sorbitol amount, xylitol amount, color, or flavoring.

There is no particular limitation on the chewing gum material used to prepare the chewing gum product. As used herein, the terms “gum,” “chewing gum,” and “bubble gum” are used interchangeably and are meant to include any gum composition. Chewing gum materials typically contain a water-insoluble gum base, sweeteners, flavors, and a variety of additional ingredients tailored to provide specific release characteristics.

The chewing gum product can be coated or uncoated, and it can be extruded and, if necessary, separated and/or shaped into the form of slabs, sticks, pellets, balls, and the like. In some embodiments, the chewing gum product comprises a clear coating to facilitate visibility of the filled capillaries. Different forms of the chewing gum material can vary with regard to the types and amounts of the ingredients. For example, coated gum compositions can contain a lower percentage of softeners. Pellets and balls can have a chewing gum core that has been coated with either a sugar solution or a sugarless solution to create a hard shell. Slabs and sticks are usually formulated to be softer in texture than the chewing gum core. In some cases, a hydroxy fatty acid salt or other surfactant active can have a softening effect on the gum base. In order to adjust for any potential undesirable softening effect that the surfactant actives can have on the gum base, it can be beneficial to formulate a slab or stick gum having a firmer texture than usual (i.e., use less conventional softener than is typically employed).

The chewing gum material can comprise a gum base, bulk sweeteners, high intensity sweeteners, flavorants, coloring agents, sensates (such as cooling agents, warming agents, and tingling agents), and any other optional additives, including throat-soothing agents, spices, tooth-whitening agents, breath freshening agents, vitamins, minerals, caffeine, drugs (e.g., medications, herbs, and nutritional supplements), oral care products, and combinations thereof.

Generally, the chewing gum material comprises a water insoluble gum base portion and a water-soluble bulk portion. The gum base can vary greatly depending upon various factors such as the type of gum base desired, the consistency of gum desired, and the other components used in the composition to make the final chewing gum product. The gum base can be any water-insoluble gum base known in the art, and includes those gum bases utilized for chewing gums and bubble gums. Illustrative examples of suitable polymers in gum bases include both natural and synthetic elastomers and rubbers. For example, natural elastomers and rubbers include substances of vegetable origin such as smoked or liquid latex and guayule, natural gums such as jelutong, lechi caspi, perillo, sorva, massaranduba balata, massaranduba chocolate, nispero, rosidinha, crown gum, chicle, gutta percha, gutta kataiu, gutta kay, niger gutta, tunu, chilte, chiquibul, gutta hang kang, and combinations thereof.

Synthetic elastomers include high molecular weight elastomers and low molecular weight elastomers. Useful high molecular weight elastomers include butadiene-styrene copolymers, polyisoprene, polyisobutylene, isobutylene-isoprene copolymers, polyethylene, and combinations thereof. Useful low molecular weight elastomers include polybutene, polybutadiene, polyisobutylene, and combinations thereof. Suitable gum bases can also include vinyl polymeric elastomers such as poly(vinyl acetate), polyethylene, vinyl copolymeric elastomers such as copolymers of vinyl acetate and vinyl laurate, copolymers of vinyl acetate and vinyl stearate, copolymers of ethylene and vinyl acetate, poly(vinyl alcohol), and combinations thereof. In some embodiments, the vinyl polymers have a number average molecular weight of about 3,000 to about 94,000 grams/mole. Vinyl polymers such as poly(vinyl alcohol) and poly(vinyl acetate) can have a number average molecular weight of about 8,000 to about 65,000 grams/mole. Furthermore, any combination of the aforementioned high and low molecular weight, natural and synthetic elastomers, and rubbers can be used as a gum base.

The amount of gum base employed can vary depending upon various factors such as the type of gum base used, the desired consistency of the chewing gum product during consumption, and the other components used in the chewing gum material. In general, the gum base can be present in an amount of about 5 to about 94 weight percent of the total chewing gum material. In some embodiments, the gum base amount is about 15 to about 45 weight percent, specifically about 15 to about 40 weight percent, more specifically about 25 to about 40 weight percent, based upon the total weight of the chewing gum material.

The water-insoluble gum base portion can further contain any combination of elastomer plasticizers, texture modifiers, waxes, softeners, fillers, and other optional ingredients such as colorants and antioxidants. Elastomer plasticizers are also commonly referred to as resins, resinous compounds, elastomer solvents, or rosins. Additives that can be included in the gum base include plasticizers, and waxes or softeners that are used in effective amounts to provide a variety of desirable textures and consistency properties. Because of the low molecular weight of these components, the texture modifying agents are able to penetrate the elastomers, making the gum base more plastic and less viscous.

The gum base material can contain conventional elastomer plasticizers to aid in softening the elastomer base component, for example terpene resins such as polymers derived from alpha-pinene, beta-pinene, and/or d-limonene; methyl, glycerol or pentaerythritol esters of rosins or modified rosins and gums, such as hydrogenated, dimerized or polymerized rosins, and combinations thereof; the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like. Any combination of the foregoing elastomer plasticizers can be used to soften or adjust the tackiness of the elastomer base component. When present, the elastomer plasticizer can be used in an amount of about 5 to about 75 weight percent of the gum base, specifically about 45 to about 70 weight percent of the gum base.

Suitable softeners include lanolin, fatty acids such as palmitic acid and oleic acid and stearic acid, sodium stearate, potassium stearate, glyceryl triacetate, glyceryl lecithin, glyceryl monostearate, propylene glycol monostearate, monoglycerides, diglycerides, triglycerides, acetylated monoglycerides, glycerin, lecithin, diacetin, and combinations thereof. Other suitable softeners include waxes. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, cocoa butter, and combinations thereof can also be incorporated into the gum base to obtain a variety of desirable textures and consistency properties.

In some embodiments, the chewing gum material contains texture modifiers. Such texture modifiers include, for example, poly(vinyl acetate), fats, butyl rubber, talc, silica, and combinations thereof.

In some embodiments, the chewing gum material contains a gum base softener. Softeners include, for example, lanolin, fatty acids such as palmitic acid and oleic acid and stearic acid, sodium stearate, potassium stearate, glyceryl triacetate, glyceryl lecithin, glyceryl monostearate, propylene glycol monostearate, monoglycerides, diglycerides, triglycerides, acetylated monoglycerides, glycerin, lecithin, diacetin, waxes, and combinations thereof. In some embodiments, the softener is present in amounts of up to about 30 weight percent of the gum base, specifically about 0.2 to about 20 weight percent of the gum base.

When a wax is present in the gum base, it softens the elastomer and improves the elasticity of the gum base. The waxes employed can have a melting point below about 60° C., and preferably about 45 to about 55° C. The low melting wax can be a paraffin wax. When present, the wax can be used in the gum base in an amount of about 6 to about 10 weight percent, and specifically about 7 to about 9.5 weight percent, based on the weight of the gum base.

In addition to the low melting point waxes, waxes having a higher melting point can be used in the gum base in amounts up to about 5 weight percent, based on the total weight of the gum base. Such high melting waxes include beeswax, vegetable wax, rice bran wax, candelilla wax, carnauba wax, polyethylene wax, microcrystalline wax, most petroleum waxes, and combinations thereof.

The gum base can include effective amounts of bulking agents such as mineral adjuvants, which can serve as fillers and textural agents. Examples of bulking agents include calcium carbonate, magnesium carbonate, alumina, aluminum hydroxide, aluminum silicate, talc, tricalcium phosphate, and combinations thereof. The amount of bulking agents, when used, can be about 15 to about 40 weight percent, specifically about 20 to about 30 weight percent, based on the total weight of the gum base.

In addition to a water insoluble gum base portion, a typical chewing gum material includes a water-soluble bulk portion and one or more flavoring agents. In some embodiments, an unencapsulated active ingredient is present in a water-soluble bulk portion of the chewing gum composition. The water-soluble portion can include sweetening agents, flavoring agents, softeners, emulsifiers, coloring agents, acidulants, fillers, antioxidants, and other conventional chewing gum additives that provide desired attributes. Any of the above-mentioned water-soluble active ingredients can also be incorporated into the water-soluble bulk portion of chewing gum composition. These and other conventional chewing gum additives known to one having ordinary skill in the art can also be incorporated into the gum base.

Sweetening agents can include sugar sweeteners, sugarless sweeteners, high intensity sweeteners, and combinations thereof. Sugar sweeteners generally include saccharides. Suitable sugar sweeteners include monosaccharides, disaccharides, and polysaccharides such as sucrose (sugar), dextrose, maltose, dextrin, xylose, ribose, glucose, mannose, galactose, fructose (levulose), lactose, invert sugar, fructooligosaccharide syrups, partially hydrolyzed starch, corn syrup solids, high fructose corn syrup, and combinations thereof. In some embodiments, the chewing gum material is sugar-free (i.e., it contains no sucrose). In some embodiments, the fill material is sugar-free. In some embodiments, the entire chewing gum product is sugar-free. In some embodiments, the chewing gum material comprises about 45 to about 75 weight percent polyol, of which at least 10 weight percent has a particle size mean diameter of about 100 to about 1500 micrometers. In these embodiments, the chewing gum material contributes crunchiness the chewing gum product in addition to that contributed by the crystallized fill material. In some embodiments, the chewing gum material comprises, based on the total weight of the chewing gum material, about 10 to about 50 weight percent isomalt having a particle size mean diameter of about 100 to about 1500 micrometers.

Suitable sugarless sweeteners include sugar alcohols (or polyols) such as sorbitol, xylitol, mannitol, galactitol, maltitol, hydrogenated isomaltulose (isomalt), lactitol, erythritol, hydrogenated starch hydrolysate, and combinations thereof. Suitable hydrogenated starch hydrolysates include those disclosed in U.S. Pat. No. 4,279,931 to Verwaerde et al. and various hydrogenated glucose syrups and/or powders, which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN, a line of commercially available products manufactured by Roquette Freres of France, and HYSTAR, a line of commercially available products manufactured by Lonza, Inc., of Fair Lawn, N.J., USA.

A “high intensity sweetener” as used herein refers to a sweetening agent having a sweetness at least 100 times that of sugar (sucrose) on a per weight basis. In some embodiments the high intensity sweetener is at least 500, at least 1,000, or at least 5,000 times that of sugar on a per weight basis. The high intensity sweetener can be selected from a wide range of materials, including water-soluble natural and artificial sweeteners, derivatives of water-soluble natural and artificial sweeteners, dipeptide based sweeteners, and protein based sweeteners. Any combination comprising two or more high intensity sweeteners can also be used. One or more of the high intensity sweeteners can further be combined with one or more of the foregoing sweeteners or sweetening agents.

The high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, and combinations of the foregoing forms.

Representative high-intensity sweeteners include (1) water-soluble sweetening agents such as dihydrochalcones, monellin, steviosides, Rebaudioside A, Rebaudioside B, Rebaudioside C, glycyrrhizin, dihydroflavenol, and polyols such as sorbitol, mannitol, maltitol, monatin, and L-aminodicarboxylic acid aminoalkenoic acid ester amides, such as those disclosed in U.S. Pat. No. 4,619,834 to Zanno et al., or a combination comprising at least one of the foregoing; (2) water-soluble artificial sweeteners such as saccharin, soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, or a combination comprising at least one of the foregoing; (3) dipeptide based sweeteners, for example the L-aspartic acid derived sweeteners such as L-aspartyl-L-phenylalanine methyl ester (Aspartame) and materials described in U.S. Pat. No. 3,492,131 to Schlatter et al., L-alpha-aspartyl-N-(2,2,4,4-tetramethyl-3-thietanyl)-D-alaninamide hydrate (Alitame), methyl esters of L-aspartyl-L-phenylglycine and L-aspartyl-L-2,5-dihydrophenyl-glycine, L-alpha-aspartyl-L-phenylglycine methyl ester, L-alpha-aspartyl-L-2,5-dihydrophenylglycine methyl ester, L-aspartyl-2,5-dihydro-L-phenylalanine; L-alpha-aspartyl-2,5-dihydrophenylalanine methyl ester, L-aspartyl-L-(1-cyclohexen)-alanine, N—(N-(3,3-dimethylbutyl)-L-alpha-aspartyl)-L-phenylalamine methyl ester (Neotame), or a combination thereof; (4) derivatives of naturally occurring water-soluble sweeteners, such as derivatives of steviosides, derivatives of Rebaudioside A, derivatives of Rebaudioside B, derivatives of Rebaudioside C, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include 1-chloro-1′-deoxysucrose; 4-chloro-4-deoxy-alpha-D-galactopyranosyl-alpha-D-fructofuranoside, 4-chloro-4-deoxygalactosucrose, 4-chloro-4-deoxy-alpha-D-galactopyranosyl-1-chloro-1-deoxy-beta-D-fructofuranoside, 4,1′-dichloro-4,1′-dideoxygalactosucrose; 1′,6′-dichloro-1′,6′-dideoxysucrose; 1,6-dichloro-1,6-dideoxy-β-D-fructofuranosyl-4-chloro-4-deoxy-α-D-galactopyranoside; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideox y-beta-D-fructofuranoside, or 4,6,1′,6′-tetrachloro4,6,1′,6′-tetradeoxygalacto-sucrose; 4,6,1′,6′-tetradeoxy-sucrose, or a combination thereof; and (5) protein based sweeteners such as thaumaoccous danielli, thaumatin, talin, and combinations thereof.

High intensity sweeteners can be encapsulated in an encapsulant such as poly(vinyl acetate). Particularly useful encapsulated high intensity sweeteners include, for example, encapsulated aspartame, encapsulated acesulfame potassium salt, and combinations thereof.

In the chewing gum product, a sweet taste can also come from flavor modulators or potentiators and/or from flavorants. Flavor modulators can impart a characteristic of their own that complements or negates a characteristic of another component. For example, flavors can be compounded to have additional sweet notes by the inclusion of flavor modulators or potentiators, such as vanilla, vanillin, ethyl maltol, furfural, ethyl propionate, lactones, and combinations thereof. The flavor modulators can be used in the amount about 0.01 to about 30 weight percent, specifically about 0.2 to about 3 weight percent of the chewing gum material depending on the desired intensity of the aromas used.

Flavor potentiators are materials that intensify, supplement, modify, or enhance the taste or aroma perception of an original material without introducing a characteristic taste or aroma perception of their own. In some embodiments, flavor potentiators are designed to intensify, supplement, modify, or enhance the perception of flavor, sweetness, tartness, umami, kokumi, saltiness, or a combination thereof. The flavor potentiators can be used in the amount about 0.01 to about 30 weight percent, specifically about 0.2 to about 3 weight percent of the chewing gum material.

Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, phyllodulcin, vanilla extract, vanilla oleoresin, vanillin, sugar beet extract (alcoholic extract), sugarcane leaf essence (alcoholic extract), compounds that respond to G-protein coupled receptors (T2Rs and T1Rs), and combinations thereof. In some embodiments, sugar acids, sodium chloride, potassium chloride, sodium acid sulfate, or a combination comprising at least one of the foregoing are used. In other embodiments, glutamates such as monosodium glutamate, monopotassium glutamate, hydrolyzed vegetable protein, hydrolyzed animal protein, yeast extract, and combinations thereof are included. Further examples include adenosine monophosphate (AMP), glutathione, and nucleotides such as inosine monophosphate, disodium inosinate, xanthosine monophosphate, guanylate monophosphate, and combinations thereof. Further examples of flavor potentiator compositions that impart kokumi are also included in U.S. Pat. No. 5,679,397 to Kuroda et al.

Flavorants (also known as flavorings, flavors or flavoring agents) that can be used include those artificial and natural flavors known in the art, for example, synthetic flavor oils, natural flavoring aromatics and/or oils, oleoresins, extracts derived from plants, leaves, flowers, fruits, and combinations comprising at least one of the foregoing flavorants. Representative flavors include oils such as, for example, spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and combinations thereof. Specific flavorants are mints such as peppermint, spearmint, artificial vanilla, cinnamon derivatives, and various fruit flavors.

Examples of artificial, natural, and synthetic fruit flavorants include, for example, coconut, coffee, chocolate, vanilla, lemon, grapefruit, orange, lime, yazu, sudachi, menthol, licorice, caramel, honey, peanut, walnut, cashew, hazelnut, almonds, pineapple, strawberry, raspberry, blackberry, tropical fruits, cherries, cinnamon, peppermint, wintergreen, spearmint, eucalyptus, and mint, fruit essence such as from apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya, and combinations thereof.

Other types of flavorants include various aldehydes and esters such as cinnamyl acetate, cinnamaldehyde, citral diethylacetal, dihydrocarvyl acetate, eugenyl formate, p-methylanisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), 2-dodecenal (citrus, mandarin), and combinations thereof.

Other potential flavors whose release profiles can be managed include a milk flavor, a butter flavor, a cheese flavor, a cream flavor, a yogurt flavor, a vanilla flavor, a tea or coffee flavor, such as a green tea flavor, a oolong tea flavor, a cocoa flavor, a chocolate flavor, a mint flavor, such as peppermint, spearmint, and Japanese mint; spicy flavors, such as asafetida, ajowan, anise, angelica, fennel, allspice, cinnamon, chamomile, mustard, cardamom, caraway, cumin, clove, pepper, coriander, sassafras, savory, zanthoxyli fructus, perilla, juniper berry, ginger, star anise, horseradish, thyme, tarragon, dill, capsicum, nutmeg, basil, marjoram, rosemary, bay leaf, and wasabi; alcoholic flavors, such as wine, whisky, brandy, rum, gin, and liqueur; floral and vegetable flavors, such as onion, garlic, cabbage, carrot, celery, mushroom, tomato, and any combinations thereof. Commonly used flavorings include mints such as peppermint, menthol, spearmint, artificial vanilla, cinnamon derivatives, and various fruit flavors, whether employed individually or in admixture. Flavors can also provide breath freshening properties, particularly the mint flavors when used in combination with cooling agents. In some embodiments, the chewing gum material can further include fruit juices.

The flavoring agents can be used in many distinct physical forms. Such physical forms include liquid and/or dried form. In some embodiments, the flavoring agents can be in free (unencapsulated) forms, spray dried forms, freeze dried forms, powdered forms, beaded forms, encapsulated forms, slices, pieces, and mixtures thereof. When employed in a spray-dried form, suitable drying means such as spray-drying a liquid can be used. Alternatively, the flavoring agent can be absorbed onto water-soluble materials, such as cellulose, starch, sugar, maltodextrin, gum Arabic, and so forth, or it can be encapsulated. In still other embodiments, the flavoring agent can be adsorbed onto water-insoluble materials such as, for example, silicas or zeolites. The particle size of the flavoring agents can be less than 3 millimeters, less than 2 millimeters, or less than 1 millimeter, calculated as the longest dimension of the particle. The natural flavoring agent can have a particle size about 3 micrometers to 2 millimeters, specifically about 4 micrometers to about 1 millimeter. The flavorants can be used in an amount of about 0.01 to about 30 weight percent, specifically about 0.2 to about 5 weight percent of the chewing gum material, depending on the desired intensity of the flavors and aromas.

The amount of flavor modulators, flavor potentiators, and flavorants used herein can be a matter of preference subject to such factors as the type of final chewing gum product, the individual flavor, and the strength of flavor desired. Thus, the amount of flavorants can be varied in order to obtain the result desired in the final product and such variations are within the capabilities of those skilled in the art without the need for undue experimentation.

In some embodiments, the chewing gum material contains aroma agents including natural and synthetic flavorings such as, for example, natural vegetable components, flavoring aromatics and/or oils, essential oils, essences, extracts, powders, food-grade acids, oleoresins and extracts derived from plants, leaves, flowers, fruits, and combinations thereof. The aroma agents can be in liquid or powdered form. The aroma agents can be used in the amount about 0.01 to about 30 weight percent, specifically about 0.2 to about 3 weight percent of the chewing gum material.

Cooling agents, also known as coolants, are additives that provide a cooling or refreshing effect in the mouth, in the nasal cavity, or on skin. Menthyl-based coolants as used herein include menthol and menthol derivatives. Menthol (also known as 2-(2-propyl)-5-methyl-1-cyclohexanol) is available in artificial form, or naturally from sources such as peppermint oil. Menthol derivatives include menthyl ester-based and menthyl carboxamide-based cooling compounds such as menthyl carboxamide, monomenthyl succinate, dimenthyl succinate, monomenthyl methyl succinate, monomenthyl glutarate, dimenthyl glutarate, menthyl 2-pyrrolidone-5-carboxylate, monomenthyl 3-methyl maleate, menthyl acetate, menthyl lactate, dimenthyl lactate, menthyl salicylate, 2-isopropanyl-5-methylcyclohexanol, 3-L-menthoxypropane-1,2-diol, menthane, menthone, menthone ketals, menthone glycerol ketals, N-ethyl-p-menthane-3-carboxamide (WS-3), or a combination thereof. Additional menthyl-based coolants, specifically menthyl carboxamides, are described in U.S. Pat. No. 7,923,577 to Bardsley et al.

Other cooling agents that can be used in combination with or in the absence of the menthyl-based coolants include, for example 2-mercapto-cyclo-decanone, hydroxycarboxylic acids with 2 to 6 carbon atoms, xylitol, erythritol, alpha-dimethyl succinate, acyclic carboxamides such as N,2,3-trimethyl-2-isopropyl butanamide (WS-23), N-ethyl-2,2-diisopropylbutanamide (ICE 10,000), and combinations thereof. Additional cooling agents include the 1-tert-butylcyclohexanecarboxamides described in U.S. Patent Application Publication Nos. US 2011/0070171 A1 and US 2011/0070329 A1 of Kazimierski et al.

Cooling compositions comprising a primary cooling compound, a secondary cooling compound, and an ingestible non-polar solvent are described in U.S. Patent Application Publication No. US 2011/0091531 A1 of Furrer et al.

Warming agents can be selected from a wide variety of compounds known to provide the sensory signal of warming to the user. These compounds offer the perceived sensation of warmth, particularly in the oral cavity, and often enhance the perception of flavors, sweeteners, and other organoleptic components. Among the useful warming compounds included are vanillyl alcohol n-butylether (TK-1000) supplied by Takasago Perfumery Company Limited, Tokyo, Japan, vanillyl alcohol methyl ether, vanillyl alcohol ethyl ether, vanillyl alcohol n-propyl ether, vanillyl alcohol isopropyl ether, vanillyl alcohol isobutyl ether, vanillyl alcohol n-pentyl ether, vanillyl alcohol isoamyl ether, vanillyl alcohol n-hexylether, gingerol, shogaol, paradol, zingerone, capsaicin, dihydrocapsaicin, nordihydrocapsaicin, homocapsaicin, homodihydrocapsaicin, ethanol, isopropyl alcohol, isoamyl alcohol, benzyl alcohol, glycerin, and combinations thereof.

Coloring agents (also known as colorants or colorings) can be used in amounts effective to produce a desired color for the confectionery material. Suitable coloring agents include pigments, which can be incorporated in amounts up to about 6 weight percent by weight of the chewing gum material. For example, titanium dioxide can be incorporated in amounts up to about 2 weight percent and specifically less than about 1 weight percent by weight of the chewing gum material. Suitable coloring agents also include natural food colors and dyes suitable for food, drug, and cosmetic applications.

Suitable colorants include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rho doxanthin (E1610, caramel (E150(a-d)), β-apo-8′-carotenal (E160e), β-carotene (E160a), alpha carotene, gamma carotene, ethyl ester of beta-apo-8 carotenal (E1600, flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), FD&C aluminum lakes, and combinations thereof.

Exemplary breath fresheners include zinc citrate, zinc acetate, zinc fluoride, zinc ammonium sulfate, zinc bromide, zinc iodide, zinc chloride, zinc nitrate, zinc fluorosilicate, zinc gluconate, zinc tartrate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based material, carbon-based material, enzymes such as laccase, and combinations thereof. Breath fresheners can include essential oils as well as various aldehydes and alcohols. Essential oils used as breath fresheners can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, orange, and combinations thereof. Aldehydes such as cinnamic aldehyde and salicylaldehyde can be used. Additionally, chemicals such as menthol, carvone, iso-garrigol, and anethole can function as breath fresheners.

Exemplary mouth moisteners include saliva stimulators such as food-grade acids and salts including acetic acid, adipic acid, ascorbic acid, butyric acid, citric acid, formic acid, fumaric acid, glyconic acid, lactic acid, phosphoric acid, malic acid, oxalic acid, succinic acid, tartaric acid, salts of any of the foregoing acids, and any combination of the foregoing acids and salts. The amount of the food-grade acid and salts thereof, when present, can be about 1 to about 40 weight percent based on the total weight of the chewing gum material. Within the range of about 1 to about 40 weight percent, the food grade acid amount can be about 1 to about 20 weight percent, specifically about 2 to about 15 weight percent, more specifically about 3 to about 10 weight percent, even more specifically about 4 to about 8 weight percent.

Mouth moisteners can include hydrocolloid materials that hydrate and can adhere to oral surface to provide a sensation of mouth moistening. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carrageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Mouth moisteners can include modified natural gums such as propylene glycol alginate, carboxymethyl locust bean gum, low methoxyl pectin, or a combination thereof. Modified celluloses can be included such as microcrystalline cellulose, carboxymethylcellulose (CMC) and its sodium salt, methylcellulose (MC), hydroxypropylmethylcellulose (HPMC), hydroxypropylcellulose (MPC), or a combination thereof.

Similarly, humectants, which can provide a perception of mouth hydration, can be included. Such humectants can include glycerol, sorbitol, polyethylene glycol, erythritol, xylitol, and combinations thereof. Additionally, in some embodiments, fats can provide a perception of mouth moistening. Such fats can include medium chain triglycerides, vegetable oils, fish oils, mineral oils, and combinations thereof.

Suitable acidulants illustratively include acetic acid, citric acid, fumaric acid, hydrochloric acid, lactic acid and nitric acid as well as sodium citrate, sodium bicarbonate, sodium carbonate, sodium or potassium phosphate, magnesium oxide, potassium metaphosphate, sodium acetate, and combinations thereof.

Exemplary buffering agents include sodium bicarbonate, sodium phosphate, sodium hydroxide, ammonium hydroxide, potassium hydroxide, sodium stannate, triethanolamine, citric acid, hydrochloric acid, sodium citrate, and combinations thereof.

In some embodiments, a tingling sensation can be provided. Tingling agents include jambu, and alkylamides extracted from materials such as jambu or sanshool.

Suitable oral care agents include breath fresheners, tooth whiteners, antimicrobial agents, tooth mineralizers, tooth decay inhibitors, topical anesthetics, mucoprotectants, stain removers, oral cleaning agents, bleaching agents, desensitizing agents, dental remineralization agents, antibacterial agents, anticaries agents, plaque acid buffering agents, surfactants and anticalculus agents, and combinations thereof. Examples of such ingredients include, hydrolytic agents including proteolytic enzymes, abrasives such as hydrated silica, calcium carbonate, sodium bicarbonate and alumina, other active stain-removing components such as surface-active agents, including anionic surfactants such as sodium stearate, sodium palmitate, sulfated butyl oleate, sodium oleate, salts of fumaric acid, glycerol, hydroxylated lecithin, sodium lauryl sulfate, and chelators such as polyphosphates, which are typically employed as tartar control ingredients. Oral care ingredients can also include tetrasodium pyrophosphate and sodium tri-polyphosphate, sodium bicarbonate, sodium acid pyrophosphate, xylitol, sodium hexametaphosphate, and combinations thereof.

In addition, suitable oral care agents include peroxides such as carbamide peroxide, calcium peroxide, magnesium peroxide, sodium peroxide, hydrogen peroxide, and peroxydiphosphate, and combinations thereof. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples include papaine, krillase, pepsin, trypsin, lysozyme, dextranase, mutanase, glycoamylase, amylase, glucose oxidase, and combinations thereof.

Suitable oral care agents include surfactants that achieve increased prophylactic action and render the oral care ingredients more cosmetically acceptable. Surfactants used as oral care agents include detersive materials that impart to the composition detersive and foaming properties. Suitable surfactants include, for example, sodium stearate, sodium ricinoleate, sodium lauryl sulfate, water-soluble salts of higher fatty acid monoglyceride monosulfates, such as the sodium salt of the monosulfated monoglyceride of hydrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid or alkyl or acyl radicals. Examples of the last mentioned amides are N-lauroyl sarcosine, and the sodium, potassium, and ethanolammonium salts of N-lauroyl sarcosine, N-myristoyl sarcosine, and N-palmitoyl sarcosine.

In addition to surfactants, oral care ingredients can include antibacterial agents such as triclosan, chlorhexidine, zinc citrate, silver nitrate, copper, limonene, cetyl pyridinium chloride, and combinations thereof.

Anticaries agents can include fluoride ion sources such as sodium fluoride, potassium fluoride, sodium fluorosilicate, ammonium fluorosilicate, potassium fluoride, sodium monofluorophosphate, stannous fluoride, potassium stannous fluoride, sodium hexafluorostannate, stannous chlorofluoride, and combinations thereof.

Further examples of anticaries agents are included in U.S. Pat. No. 5,227,154 to Reynolds, U.S. Pat. No. 5,378,131 to Greenberg, and U.S. Pat. No. 6,685,916 to Holme et al.

Throat care or throat-soothing ingredients include analgesics, antihistamines, anesthetics, demulcents, mucolytics, expectorants, antitussive, and antiseptics. In some embodiments, throat-soothing agents include honey, propolis, aloe vera, glycerine, menthol and a combination thereof is employed.

Medicaments can be included in the chewing gum product as a component of the chewing gum fill material. Non-limiting illustrative categories and specific examples include antihistamines, decongestants (sympathomimetics), antitussives (cough suppressants), expectorants, anesthetics, analgesics, demulcents, antibacterial agents, antiviral agents, anti-inflammatories, antacids, antifungal agents, chemotherapeutics, diuretics, psychotherapeutic agents, homeopathic agents, anticholinergics, throat-soothing agents, antinauseants, cardiovascular agents, various alkaloids, laxatives, appetite suppressants, ACE-inhibitors, anti-asthmatics, anti-cholesterolemics, anti-depressants, anti-diarrhea preparations, anti-hypertensives, anti-lipid agents, acne drugs, amino acid preparations, anti-uricemic drugs, anabolic preparations, appetite stimulants, bone metabolism regulators, contraceptives, endometriosis management agents, enzymes, erectile dysfunction therapies such as sildenafil citrate, fertility agents, gastrointestinal agents, homeopathic remedies, hormones, motion sickness treatments, muscle relaxants, osteoporosis preparations, oxytocics, parasympatholytics, parasympathomimetics, prostaglandins, respiratory agents, sedatives, smoking cessation aids such as bromocryptine or nicotine, tremor preparations, urinary tract agents, anti-ulcer agents, anti-emetics, hyper- and hypo-glycemic agents, thyroid and anti-thyroid preparations, terine relaxants, erythropoietic drugs, mucolytics, DNA and genetic modifying drugs, and nutritional supplements, including nutraceuticals, micronutrients, vitamins and co-enzymes. The pharmaceutically acceptable salts and prodrugs of the medicaments are also included unless specified otherwise. Some of these medicaments can serve more than one purpose. Combinations of the foregoing types of optional medicaments can be used. Two or more medicaments that have activity against the same or different symptoms can be used together in a combination.

Medicaments for the treatment of a cough, or a cold or flu symptom include elements, compounds or materials, alone or in combination, that have been used for, or have been shown to be useful for, the amelioration of at least one symptom commonly associated with cough, colds, or influenza. It is to be understood that a “medicament for the treatment of a cough, or a cold or flu symptom” includes medicaments that are also useful for the treatment of cold-like or flu-like symptoms arising from other sources, such as, for example, allergies or adverse environmental conditions. Cold, cold-like, flu, and flu-like symptoms as used herein include, for example, cough, coryza, nasal congestion, upper respiratory infections, allergic rhinitis, otitis, sinusitis, sneezing, and the discomfort, pain, fever and general malaise associated with colds, flu, allergies, and adverse environmental conditions.

Examples of general categories of medicaments for the treatment of a cough, or a cold or flu symptom include antihistamines, decongestants (sympathomimetics), antitussives (cough suppressants), anti-inflammatories, homeopathic agents, expectorants, anesthetics, demulcents, analgesics, anticholinergics, throat-soothing agents, antibacterial agents, and antiviral agents. Some of these medicaments can serve more than one purpose. The pharmaceutically acceptable salts and prodrugs of the medicaments are also included unless specified otherwise. Two or more medicaments that have activity against the same or different symptoms of colds or coughs can be used together in a combination.

Exemplary antihistamines include azatadine, bromodiphenhydramine, brompheniramine, brompheniramine maleate, carbinoxamine, carbinoxamine maleate, cimetidine, chlorpheniramine, chlorpheniramine maleate, dexchlorpheniramine, diphenhydramine, diphenhydramine hydrochloride, doxylamine, phenindamine, pheniramine, phenyltoloxamine, pyrilamine, promethazine, triprolidine, loratadine, ranitidine, chlorcyclizine, terfenadine, clemastine fumarate, dimenhydrinate, prilamine maleate, tripelennamine hydrochloride, tripelennamine citrate, hydroxyzine pamoate, hydroxyzine hydrochloride, cyclizine lactate, cyclizine hydrochloride, meclizine hydrochloride, acrivastine, cetirizine hydrochloride, astemizole, levocabastine hydrochloride, cetirzine, and combinations thereof.

Exemplary decongestants include agents such as levopropoxyphene napsylate, noscapine, carbetapentane, caramiphen, chlophedianol, pseudoephedrine hydrochloride, phenylephrine, phenylpropanolamine, diphenhydramine, glaucine, pholcodine, benzonatate, ephedrine, ephinephrine, levodesoxyephedrine, oxymetazoline, naphazoline, propylhexedrine, xylometazoline, and combinations thereof.

Antitussives help relieve coughing. Examples of antitussives include codeine, dihydrocodeine, hydrocodone and hydromorphone, carbetapentane, caramiphen, hydrocodone bitartrate, chlorphedianol, noscarpine, dextromethorphan, and combinations thereof.

Expectorants include guaifenesin, aniseed, blood root, coltsfoot, elderflower, golden seal, grindelia, hyssop, lungwort, mullein, senega, thuja, thyme, vervain, glyceryl guaiacolate, terpin hydrate, N-acetylcysteine, bromhexine, ambroxol, domiodol, 3-iodo-1,2-propanediol and wild cherry, ammonium chloride, calcium iodide, iodinated glycerol, potassium guaiacolsulfonate, potassium iodide, sodium citrate, and combinations thereof.

Anaesthetics include etomidate, ketamine, propofol, and benodiazapines (e.g., chlordiazepoxide, diazepam, clorezepate, halazepam, flurazepam, quazepam, estazolam, triazolam, alprozolm, midazolam, temazepam, oxazepam, lorazepam), benzocaine, dyclonine, bupivacaine, etidocaine, lidocaine, mepivacaine, promoxine, prilocaine, procaine, proparcaine, ropivacaine, tetracaine, and combinations thereof. Other useful agents can include amobarbital, aprobarbital, butabarbital, butalbital mephobarbital, methohexital, pentobarbital, phenobarbital, secobarbital, thiopental, paral, chloral hydrate, ethchlorvynol, clutethimide, methprylon, ethinamate, meprobamate, and combinations thereof.

Analgesics include opioids such as morphine, mepidine, dentanyl, sufentranil, alfentanil, aspirin, salicylamide, sodium salicylate, acetaminophen, ibuprofen, indomethacine, naproxen, atrin, isocome, midrin, axotal, firinal, phrenilin, ergot and ergot derivatives (wigraine, cafergot, ergostat, ergomar, dihydroergotamine), imitrex, and combinations thereof.

Anticholinergics include homatropine, atropine, scopolamine hydrogen bromide, L-hyoscyamine, L-alkaloids of belladonna, tincture of belladonna alkaloids, homatropine hydrogen bromide, homatropine methylbromide, methscopolamine, anisotropine, anisotropine with phenobarbital, clindinium, glycopyrrolate, hexocyclim, isopropamide, mepenzolate, methantheline, oxyphencyclimine, propantheline, tridihexethyl, dicyclomine, scopolamine, atropine, dicyclomine, flavoxate, ipratropium, oxybutynin, pirenzepine, tiotropium, tolterodine, tropicamide, trimethaphan, atracurium, doxacurium, mivacurium, pancuronium, tubocurarine, vecuronium, suxamethonium chloride, and combinations thereof.

Demulcents include coltsfoot, comfrey, corn silk, couchgrass, flaxseed, irish moss, lungwort, liquorice, mallow, marshmallow, mullein, oatmeal, parsley piert, slippery elm, and combinations thereof.

Antibacterial agents include those within the antibiotic classes of aminoglycosides, cephalosporins, macrolides, penicillins, quinolones, sulfonamides, and tetracyclines. Specific exemplary antibiotic agents include naficillin, oxacillin, vancomycin, clindamycin, erythromycin, trimethoprim-sulphamethoxazole, rifampin, ciprofloxacin, broad spectrum penicillin, amoxicillin, gentamicin, ceftriazoxone, cefotaxime, chloramphenicol, clavunate, sulbactam, probenecid, doxycycline, spectinomycin, cefixime, penicillin G, minocycline, β-lactamase inhibitors; meziocillin, piperacillin, aztreonam, norfloxacin, trimethoprim, ceftazidime, dapsone, neomycin, azithromycin, clarithromycin, amoxicillin, ciprofloxacin, and vancomycin.

Antiviral agents specifically or generally modulate the biological activity of viruses such as picornavirus, influenza virus, herpes viruses, herpes simplex, herpes zoster, enteroviruses, varicella and rhinovirus, which are associated with the common cold. Exemplary antiviral agents include acyclovir, trifluridine, idoxorudine, foscarnet, ganciclovir, zidovudine, dideoxycytosine, dideoxyinosine, dipyridamole, stavudine, cidofovir, famciclovir, valaciclovir, valganciclovir, acyclovir, didanosine, zalcitabine, rifimantadine, saquinavir, indinavir, ritonavir, ribavarin, nelfinavir, adefovir, nevirapine, delavirdine, efavirenz, abacavir, amantadine, emtricitabine, entecavir, tenofovir, zanamivir, oseltamivir, ICI 130,685, impulsin, pleconaril, penciclovir, vidarabine, cytokines, and combinations thereof.

Anti-inflammatories include salicylic acid derivatives including aspirin, paraminophenol derivatives including acetaminophen, indole and indene acetic acids including indomethacin, sulindac and etodalac, heteroaryl acetic acids including tolmetin diclofenac and ketorolac, aryl propionic acid derivatives including ibuprofen, naproxen, ketoprofen, fenopren, ketorlac, carprofen, oxaprozine, anthranilic acids including mefenamic acid, meclofenamic acid, and enolic acids including piroxicam, tenoxicam, phenylbutazone and oxyphenthatrazone.

Antacids include cimetidine, ranitidine, nizatidine, famotidine, omeprazole, bismuth antacids, metronidazole antacids, tetracycline antacids, clarthromycin antacids, hydroxides of aluminum, magnesium, sodium bicarbonates, calcium bicarbonate and other carbonates, silicates, phosphates, and combinations thereof.

Antifungal agents include, for example, ketoconazole, fluconazole, nystatin, itraconazole, clomitrazole, natamycin, econazole, isoconazole, oxiconazole, thiabendazole, tiaconazole, voriconazole, terbinafine, amorolfine, micfungin, amphotericin B, and combinations thereof.

Chemotherapeutics agents include cisplatin (CDDP), procarbazine, mechlorethamine, cyclophosphamide, camptothecin, ifosfamide, melphalan, chlorambucil, bisulfan, nitrosurea, dactinomycin, daunorubicin, doxorubicin, bleomycin, plicomycin, mitomycin, etoposide (VP16), tamoxifen, taxol, transplatinum, 5-fluorouracil, vincristin, vinblastin and methotrexate and analogs or derivative variants thereof, and combinations thereof.

Diuretics include but are not limited to acetazolamide, dichlorphenamide, methazolamide, furosemide, bumetanide, ethacrynic acid torseimde, azosemide, muzolimine, piretanide, tripamide, bendroflumethiazide, benzthiazide, chlorothiazide, hydrochlorothiazide, hydroflumethiazide, methyclothiazide, polythiazide, trichlormethiazide, indapamide, metolazone, quinethazone, amiloride, triamterene, sprionolactone, canrenone, potassium canrenoate, and combinations thereof.

Psychotherapeutic agents include thorazine, serentil, mellaril, millazine, tindal, permitil, prolixin, trilafon, stelazine, suprazine, taractan, navan, clozaril, haldol, halperon, loxitane, moban, orap, risperdal, alprazolam, chlordiaepoxide, clonezepam, clorezepate, diazepam, halazepam, lorazepam, oxazepam, prazepam, buspirone, elvavil, anafranil, adapin, sinequan, tofranil, surmontil, asendin, norpramin, pertofrane, ludiomil, pamelor, vivactil, prozac, luvox, paxil, zoloft, effexor, welbutrin, serzone, desyrel, nardil, parnate, eldepryl, and combinations thereof.

Appetite suppressants include benzphetamine, diethylpropion, mazindol, phendimetrazine, phentermine, hoodia, ephedra, and caffeine. Additional appetite suppressant are commercially under the following trade names: Adipex, Adipost, Bontril PDM, Bontril Slow Release, Didrex, Fastin, Ionamin, Mazanor, Melfiat, Obenix, Phendiet, Phendiet-105, Phentercot, Phentride, Plegine, Prelu-2, Pro-Fast, PT 105, Sanorex, Tenuate, Sanorex, Tenuate, Tenuate Dospan, Tepanil Ten-Tab, Teramine, Zantryl and combinations thereof.

Nutraceuticals and micronutrients include herbs and botanicals such as aloe, bilberry, bloodroot, calendula, capsicum, chamomile, cat's claw, echinacea, garlic, ginger, gingko, goldenseal, various ginseng, green tea, golden seal, guarana, kava kava, lutein, nettle, passionflower, rosemary, saw palmetto, St. John's wort, thyme, valerian, and combinations thereof. Also included are mineral supplements such as calcium, copper, iodine, iron, magnesium, manganese, molybdenum, phosphorous, zinc, selenium, and combinations thereof. Other nutraceuticals that can be added include fructooligosaccharides, glucosamine, grapeseed extract, cola extract, guarana, ephedra, inulin, phytosterols, phytochemicals, catechins, epicatechin, epicatechin gallate, epigallocatechin, epigallocatechin gallate, isoflavones, lecithin, lycopene, oligofructose, polyphenols, flavanoids, flavanols, flavonols, and psyllium as well as weight loss agents such as chromium picolinate and phenylpropanolamine. Vitamins and co-enzymes include water or fat-soluble vitamins such as thiamin, riboflavin, nicotinic acid, pyridoxine, pantothenic acid, biotin, folic acid, flavin, choline, inositol and paraminobenzoic acid, carnitine, vitamin C, vitamin D and its analogs, vitamin A and the carotenoids, retinoic acid, vitamin E, vitamin K, vitamin B₆, vitamin B₁₂, and combinations thereof. Combinations comprising at least one of the foregoing nutraceuticals can be used.

The amount of medicament or its acid addition salt used in the chewing gum material varies depending upon the therapeutic dosage recommended or permitted. In general, the amount of medicament present is the ordinary dosage used in the treatment of cough, or cold or flu symptoms. Such dosages are known to the skilled practitioner.

Specific optional, additional medicaments that can be used include caffeine, cimetidine, ranitidine, famotidine, omeprazole, dyclonine, nicotine, and combinations thereof.

Antioxidants include natural and artificial anti-oxidants like beta-carotenes, acidulants e.g. Vitamin C, propyl gallate, butyl hydroxyanisole, butylated hydroxytoluene, Vitamin E, Carnosic acid, Rosmanol, rosmaridiphenol, and the like, and combinations thereof.

Preservatives include any natural and synthetic preservatives that improve shelf life of a confectionery product. Suitable preservatives include propanoic acid, benzoic acid, and sorbic acid.

The extruded body portion of the chewing gum product comprises a plurality of capillaries. It should be understood that the term “plurality” is intended to mean two or more. In some embodiments, a plurality is three or more, or four or more, or five or more, or six or more, or seven or more. There is no particular upper limit on the number associated with “plurality”. In some embodiments, the plurality of capillaries of the chewing gum product is three capillaries.

The plurality of capillaries disposed in the extruded body portion of the chewing gum material can have any suitable dimensions, and can have a regular or irregular profile. The largest cross-sectional dimension can be about 0.1 to about 5 millimeters, or about 0.2 to about 4 millimeters, specifically about 0.5 to about 3 millimeters, or more specifically about 0.7 to about 1.2 millimeters. Typically, the capillaries have an approximately circular cross-section. In some embodiments, the capillaries have a diameter of about 0.1 to about 5 millimeters. Within the range of about 0.1 to about 5 millimeters, the capillaries can have a width or diameter of about 0.2 to about 4 millimeters, specifically the capillaries can have a width or diameter of about 0.5 to about 3 millimeters, more specifically the capillaries can have a diameter of about 0.7 to about 1.2 millimeters.

In some embodiments, at least one capillary is separated from an adjacent capillary by a wall formed from the extruded body portion, and the wall between the capillaries has a thickness of no more than the width or diameter of the capillaries.

The capillaries can extend along the substantially entire length of the body portion, but can in some embodiments extend about 75%, 80%, 90%, or 95% along the length of the body portion (for example, when it is desired to seal the ends of the body portion). When the capillaries extend along the entire length of body portion, suitably the ends of the capillaries are visible at one or more ends of the body portion.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The invention includes at least the following embodiments.

### Embodiment 1

A method of forming a chewing gum product, the method comprising: extruding a chewing gum material to form an extruded body portion and a plurality of capillaries disposed in the extruded body portion; adding a fill material to at least one capillary to form a filled extruded body; and separating the filled extruded body to form the chewing gum product; wherein the fill material comprises, based on the total weight of the fill material, about 20 to about 80 weight percent sorbitol, and about 20 to about 80 weight percent xylitol; wherein the total of sorbitol and xylitol is at least 80 weight percent.

### Embodiment 2

The method of embodiment 1, wherein the fill material during the addition to at least one capillary comprises, based on the total weight of the fill material, about 1 to about 20 weight percent crystalline sorbitol and/or xylitol, and about 80 to about 99 weight percent liquid sorbitol and xylitol.

### Embodiment 3

The method of embodiment 2, wherein the fill material during the addition to at least one capillary comprises, based on the total weight of the fill material, about 5 to about 15 weight percent of the crystalline sorbitol and/or xylitol, and about 85 to about 95 weight percent liquid sorbitol and xylitol.

### Embodiment 4

The method of embodiment 2 or 3, wherein the crystalline sorbitol and/or xylitol comprises, based on the total weight of crystalline sorbitol and/or xylitol, about 20 to about 40 weight percent crystalline sorbitol and about 60 to about 80 weight percent crystalline xylitol.

### Embodiment 5

The method of any of embodiments 2-4, wherein the liquid sorbitol and xylitol comprises, based on the total weight of liquid sorbitol and xylitol, about 20 to about 40 weight percent sorbitol and about 60 to about 80 weight percent xylitol.

### Embodiment 6

The method of any of embodiments 2-5, further comprising forming the fill material prior to said adding the fill material to at least one capillary; wherein said forming the fill material comprises blending about 1 to about 20 weight percent crystalline sorbitol and/or xylitol, and about 80 to about 99 weight percent liquid sorbitol and xylitol, based on the total weight of the fill material.

### Embodiment 7

The method of any of embodiments 1-5, wherein said extruding a chewing gum material is simultaneous with said adding a fill material to at least one capillary.

### Embodiment 8

The method of any of embodiments 1-7, wherein the fill material comprises less than or equal to 5 weight percent water, based on the total weight of fill material.

### Embodiment 9

The method of any of embodiments 1-8, wherein the fill material comprises less than or equal to 0.1 weight percent thickening agent, based on the total weight of fill material.

### Embodiment 10

The method of any of embodiments 1-9, wherein the fill material comprises the sorbitol and xylitol in a weight ratio of about 20:80 to about 40:60.

### Embodiment 11

The method of any of embodiments 1-10, wherein the total of sorbitol and xylitol in the fill material is at least 90 weight percent, based on the total weight of the fill material.

### Embodiment 12

The method of any of embodiments 1-11, wherein said extruding a chewing gum material comprises extruding the chewing gum material at a temperature of about 30 to about 50° C.

### Embodiment 13

The method of said embodiments 1-12, wherein said adding a fill material to at least one capillary comprises adding the fill material at a temperature of about 60 to about 80° C.

### Embodiment 14

The method of any of embodiments 1-13, further comprising cooling the chewing gum product to harden the fill material.

### Embodiment 15

The method of any of embodiments 1-14, further comprising crystallizing the fill material to form crystals having at least one dimension of at least 20 micrometers.

### Embodiment 16

The method of any of embodiments 1-15, wherein the chewing gum product comprises about 60 to about 90 weight percent of the chewing gum material, and about 10 to about 40 weight percent of the fill material.

### Embodiment 17

The method of any of embodiments 1-16, wherein said adding a fill material to at least one capillary comprises adding a fill material to a first capillary and adding a different fill material to a second capillary.

### Embodiment 18

The method of embodiment 1, wherein the fill material comprises less than or equal to 5 weight percent water, based on the total weight of fill material; wherein the fill material comprises less than or equal to 0.05 weight percent thickening agent, based on the total weight of fill material; wherein the fill material comprises the sorbitol and xylitol in a weight ratio of about 20:80 to about 40:60; wherein the total of sorbitol and xylitol in the fill material is at least 90 weight percent; wherein the adding a fill material to at least one capillary comprises adding the fill material at a temperature of about 60 to about 80° C.; and wherein the chewing gum product comprises about 60 to about 90 weight percent of the chewing gum material, and about 10 to about 40 weight percent of the fill material.

### Embodiment 19

The method of embodiment 18, wherein the fill material during the addition to at least one capillary comprises, based on the total weight of the fill material, about 1 to about 20 weight percent crystalline sorbitol and/or xylitol, and about 80 to about 99 weight percent liquid sorbitol and xylitol.

### Embodiment 20

A chewing gum product prepared by the method of any of embodiments 1-19.

### Embodiment 21

A chewing gum product, comprising: an extruded body portion comprising a chewing gum material; and a plurality of capillaries disposed in the extruded body portion, at least one of the capillaries comprising a fill material comprising, based on the total weight of the fill material, about 20 to about 80 weight percent sorbitol, and about 20 to about 80 weight percent xylitol; wherein the total of sorbitol and xylitol is at least 80 weight percent, based on the total weight of the fill material.

### Embodiment 22

The chewing gum product of embodiment 21, wherein the fill material comprises less than or equal to 5 weight percent water, based on the total weight of fill material.

### Embodiment 23

The chewing gum product of embodiment 21 or 22, wherein the fill material comprises less than or equal to 0.1 weight percent thickening agent, based on the total weight of fill material.

### Embodiment 24

The chewing gum product of any of embodiments 21-23, wherein the fill material comprises the sorbitol and xylitol in a weight ratio of about 20:80 to about 40:60.

### Embodiment 25

The chewing gum product of any of embodiments 21-24, wherein the total of sorbitol and xylitol in the fill material is at least 90 weight percent, based on the total weight of the fill material.

### Embodiment 26

The chewing gum product of any of embodiments 21-25, comprising about 60 to about 90 weight percent of the chewing gum material, and about 10 to about 40 weight percent of the fill material.

### Embodiment 27

The chewing gum product of embodiment 21, wherein the fill material comprises less than or equal to 5 weight percent water, based on the total weight of fill material; wherein the fill material comprises less than or equal to 0.05 weight percent thickening agent, based on the total weight of fill material; wherein the fill material comprises the sorbitol and xylitol in a weight ratio of about 20:80 to about 40:60; wherein the total of sorbitol and xylitol in the fill material is at least 90 weight percent; and wherein the chewing gum product comprises about 60 to about 90 weight percent of the chewing gum material, and about 10 to about 40 weight percent of the fill material.

### Embodiment 28

The chewing gum product of any of embodiments 21-27, comprising a first capillary comprising a first fill material, and a second capillary comprising a second fill material different from the first fill material.

The invention is further illustrated by the following non-limiting examples.

### Preparative Examples 1-11

These examples illustrate the preparation of fill materials for use in the chewing gum product. Xylitol used in these examples had a mean particle size of about 90 micrometers. Sorbitol used in these examples had a mean particle size of about 250 micrometers. The fill materials were prepared by mixing a melt composition comprising xylitol and sorbitol with a seed composition comprising xylitol and sorbitol to form a fill material. In Table 1, “Melt xylitol (%)” is the weight percent of xylitol in the melt composition, based on the total weight of the melt composition. “Melt sorbitol (%)” is the weight percent of sorbitol in the melt composition, based on the total weight of the melt composition. “Seed xylitol (%)” is the weight percent of xylitol in the seed composition, based on the total weight of the seed composition. “Seed sorbitol (%)” is the weight percent of sorbitol in the seed composition based on the total weight of the seed composition. “Melt (%)” is the weight percent of the melt composition, based on the total weight of the fill material. “Seed (%)” is the weight percent of the seed composition, based on the total weight of the fill material. “Total xylitol (%)” is the weight percent of total xylitol (melt composition xylitol plus seed composition xylitol), based on the total weight of the fill material. “Total sorbitol (%)” is the weight percent of total sorbitol (melt composition sorbitol plus seed composition sorbitol), based on the total weight of the fill material.

Melt compositions were prepared by melting xylitol and sorbitol in a stirred and scraped steam-jacketed kettle at 120° C. The resulting homogeneous mass was cooled to 72° C. before adding the seed composition, which had been prepared by dry blending xylitol and sorbitol. The resulting fill material was held at 75° C. until used to form the chewing gum product.

TABLE 1

| | P. | P. | P. | P. | P. | P. |
|---|---|---|---|---|---|---|
| | Ex. 1 | Ex. 2 | Ex. 3 | Ex. 4 | Ex. 5 | Ex. 6 |
| Melt xylitol (%) | 43.40 | 43.40 | 43.40 | 43.40 | 70.00 | 70.00 |
| Melt sorbitol (%) | 53.60 | 53.60 | 53.60 | 53.60 | 30.00 | 30.00 |
| Seed xylitol (%) | 43.40 | 43.40 | 43.40 | 43.40 | 70.00 | 70.00 |
| Seed sorbitol (%) | 53.60 | 53.60 | 53.60 | 53.60 | 30.00 | 30.00 |
| Melt (%) | 100.00 | 99.00 | 95.00 | 90.00 | 100.00 | 99.00 |
| Seed (%) | 0.00 | 1.00 | 5.00 | 10.00 | 0.00 | 1.00 |
| Total xylitol (%) | 43.40 | 43.40 | 43.40 | 43.40 | 70.00 | 70.00 |
| Total sorbitol (%) | 53.60 | 53.60 | 53.60 | 53.60 | 30.00 | 30.00 |

| | P. | P. | P. | P. | P. |
|---|---|---|---|---|---|
| | Ex. 7 | Ex. 8 | Ex. 9 | Ex. 10 | Ex. 11 |
| Melt xylitol (%) | 70.00 | 70.00 | 70.00 | 70.00 | 70.00 |
| Melt sorbitol (%) | 30.00 | 30.00 | 30.00 | 30.00 | 30.00 |
| Seed xylitol (%) | 70.00 | 70.00 | 50.00 | 50.00 | 50.00 |
| Seed sorbitol (%) | 30.00 | 30.00 | 50.00 | 50.00 | 50.00 |
| Melt (%) | 95.00 | 90.00 | 99.00 | 95.00 | 90.00 |
| Seed (%) | 5.00 | 10.00 | 1.00 | 5.00 | 10.00 |
| Total xylitol (%) | 70.00 | 70.00 | 69.80 | 69.00 | 68.00 |
| Total sorbitol (%) | 30.00 | 30.00 | 30.20 | 31.00 | 32.00 |

### Examples 1-11

These examples illustrate the preparation of chewing gum products.

Compositions of the chewing gum material and the fill material are summarized in Table 2, where component amounts are expressed in parts by weight. Maltitol used in these examples had a mean particle size of about 35 micrometers. The isomalt associated with the Table 2 row labeled “Isomalt (%)” had a mean particle size of about 40 micrometers. The isomalt associated with the Table 2 row labeled “Isomalt F (%)” had a mean particle size of 480 micrometers. The component associated with the Table 2 row labeled “LYCASIN 75/55 (%)” is a maltitol syrup (i.e., hydrogenated hydrolyzed starch) containing 75 weight percent solids based on the total weight of the maltitol syrup, and 55 weight percent maltitol based on the total solids in the maltitol syrup. The rows associated with the CHEWING GUM MATERIAL section of Table 2 provide the amounts of the respective components in weight percent based on the total weight of the chewing gum material. The rows associated with the FILL MATERIAL section of Table 2 have the meanings described in the preceding preparative examples.

The chewing gum material was prepared according to a conventional gum blending procedure. In a representative gum blending procedure, a mixing kettle is pre-heated to 38° C. All polyols except for the Isomalt F are added to the kettle with the coloring agents, and the resulting blend is mixed for 30 seconds. Gum base and softener are then added to the kettle and heated to a temperature of 85-100° C. Mixing of the gum base and softener is conducted for four minutes. The flavoring agents and cooling agents are combined and added to the kettle over the course of 30 seconds with mixing. The Isomalt F is then added to the kettle, and mixing is conducted for three minutes. The temperature of the mixture is reduced to less than 48° C., then the encapsulated and unencapsulated high intensity sweeteners are added, and mixing is conducted for four minutes.

The fill material was prepared using the procedure described in the preceding preparative examples.

TABLE 2

| | | | | | |
|---|---|---|---|---|---|
| Ex. 1 | Ex. 2 | Ex. 2 | Ex. 4 | Ex. 5 | Ex. 6 |

CHEWING GUM MATERIAL

| | | | | | | |
|---|---|---|---|---|---|---|
| Flavoring (%) | 4.5 | 4.5 | 4.5 | 4.5 | 4.5 | 4.5 |
| Maltitol (%) | 35.3 | 35.3 | 35.3 | 35.3 | 35.3 | 35.3 |
| Sorbitol (%) | 10.0 | 10.0 | 10.0 | 10.0 | 10.0 | 10.0 |
| Isomalt (%) | 10.0 | 10.0 | 10.0 | 10.0 | 10.0 | 10.0 |
| Isomalt F (%) | 0.0 | 0.0 | 0.0 | 0.0 | 0.0 | 0.0 |
| LYCASIN 75/55 (%) | 4.5 | 4.5 | 4.5 | 4.5 | 4.5 | 4.5 |
| Gum base (%) | 35.0 | 35.0 | 35.0 | 35.0 | 35.0 | 35.0 |

FILL MATERIAL

| | | | | | | |
|---|---|---|---|---|---|---|
| Melt xylitol (%) | 46.4 | 46.6 | 46.4 | 70.1 | 70.0 | 70.0 |
| Melt sorbitol (%) | 53.6 | 53.4 | 53.6 | 29.9 | 30.0 | 30.0 |
| Seed xylitol (%) | 0.0 | 46.5 | 46.9 | 100.0 | 100.0 | 70.0 |
| Seed sorbitol (%) | 0.0 | 53.5 | 53.1 | 0.0 | 0.0 | 30.0 |
| Melt (%) | 100.0 | 90.0 | 95.0 | 95.0 | 90.0 | 99.0 |
| Seed (%) | 0.0 | 10.0 | 5.0 | 5.0 | 10.0 | 1.0 |
| Total xylitol (%) | 46.4 | 46.6 | 46.4 | 71.6 | 73.0 | 70.0 |
| Total sorbitol (%) | 53.6 | 53.4 | 53.6 | 28.4 | 27.0 | 30.0 |

| | | | | |
|---|---|---|---|---|
| Ex. 7 | Ex. 8 | Ex. 9 | Ex. 10 | Ex. 11 |

CHEWING GUM MATERIAL

| | | | | | |
|---|---|---|---|---|---|
| Flavoring (%) | 4.5 | 4.5 | 4.5 | 4.5 | 4.5 |
| Maltitol (%) | 35.3 | 33.8 | 20.9 | 22.9 | 33.8 |
| Sorbitol (%) | 10.0 | 10.0 | 10.0 | 10.0 | 10.0 |
| Isomalt (%) | 10.0 | 10.0 | 10.0 | 10.0 | 10.0 |
| Isomalt F (%) | 0.0 | 0.0 | 15.0 | 10.0 | 0.0 |
| LYCASIN 75/55 (%) | 4.5 | 5.0 | 3.0 | 4.0 | 5.0 |
| Gum base (%) | 35.0 | 35.0 | 35.0 | 37.0 | 35.0 |

FILL MATERIAL

| | | | | | |
|---|---|---|---|---|---|
| Melt xylitol (%) | 46.6 | 46.4 | 46.4 | 46.4 | 70.0 |
| Melt sorbitol (%) | 53.4 | 53.6 | 53.6 | 53.6 | 30.0 |
| Seed xylitol (%) | 46.5 | 46.9 | 46.5 | 46.5 | 70.4 |
| Seed sorbitol (%) | 53.5 | 53.1 | 53.5 | 53.5 | 29.6 |
| Melt (%) | 90.0 | 95.0 | 90.0 | 90.0 | 90.0 |
| Seed (%) | 10.0 | 5.0 | 10.0 | 10.0 | 10.0 |
| Total xylitol (%) | 46.6 | 46.4 | 46.4 | 46.4 | 70.1 |
| Total sorbitol (%) | 53.4 | 53.6 | 53.6 | 53.6 | 29.9 |

To form the chewing gum product, extrusion of the chewing gum material and addition of the fill material were simultaneous, the fill material temperature during addition to capillaries was 72-78° C., and the temperature of the chewing gum material during extrusion was about 40-45° C. The extrusion rate of the chewing gum material and the pumping rate of the fill material were adjusted to provide an extrudate with 75-85% chewing gum material and 15-25% fill material. The fill material was deposited in capillaries having a diameter of about 3.5 millimeters, adjacent capillaries being separated by a wall having a thickness of about 1.2 millimeters. The extrudate was air-cooled in a cooling tunnel for about 1.5-2 minutes at 2-4° C., which resulted in cooling the filled extrudate to about 20° C. The cooled extrudate was cut to chewing gum product (pieces) having approximate dimensions 35 millimeters by 11 millimeters by 5.5 millimeters, then wrapped. Cooling in the cooling tunnel was sufficient to avoid leakage of the fill material during cutting of the extrudate.

### Example 11

This example illustrates the preparation of a chewing gum product with flavoring in the fill material.

Compositions of the chewing gum material and the fill material are summarized in Table 3. The “encapsulated aspartame” contained 30 weight percent aspartame and 70 weight percent of a poly(vinyl acetate)-based encapsulant, based on the total weight of the encapsulated aspartame. The “encapsulated acesulfame-K” contained 30 weight percent acesulfame-K and 70 weight percent a poly(vinyl acetate)-based encapsulant, based on the total weight of the encapsulated acesulfame-K.

The chewing gum material was prepared according to the general procedure described in the previous examples. The fill material was prepared as described in the preparative examples above, except that the flavoring was added just after addition of the seed composition. The chewing gum product was prepared according to the general procedure described in the previous examples.

The presence of flavoring in the fill material had no noticeable adverse effect (e.g., it did not cause leakage, nor did it interfere with hardening or crystallization).

TABLE 3

| | Ex. 11 |
|---|---|
| Flavoring (%) | 4.50 |
| Maltitol (%) | 27.97 |
| Sorbitol (%) | 10.00 |
| Isomalt (%) | 10.00 |
| Isomalt F (%) | 5.00 |
| LYCASIN 75/55 (%) | 4.00 |
| Aspartame (%) | 0.24 |
| Acesulfame-K (%) | 0.06 |
| Encapsulated aspartame (%) | 0.68 |
| Encapsulated acesulfame-K (%) | 0.23 |
| Blue dye (%) | 0.03 |
| Lecithin (%) | 0.30 |
| Gum base (%) | 37.00 |
| Flavoring (%) | 0.45 |
| Melt xylitol (%) | 70.00 |
| Melt sorbitol (%) | 30.00 |
| Seed xylitol (%) | 70.00 |
| Seed sorbitol (%) | 30.00 |
| Melt (%) | 90.00 |
| Seed (%) | 10.00 |
| Total xylitol (%) | 69.54 |
| Total sorbitol (%) | 29.80 |

1. A method of forming a chewing gum product, the method comprising:
extruding a chewing gum material to form an extruded body portion and a plurality of capillaries disposed in the extruded body portion;
adding a fill material to at least one capillary to form a filled extruded body; and
separating the filled extruded body to form the chewing gum product;
wherein the fill material comprises, based on the total weight of the fill material,
about 20 to about 80 weight percent sorbitol, and
about 20 to about 80 weight percent xylitol;
wherein the total of sorbitol and xylitol is at least 80 weight percent.

2. The method of claim 1, wherein the fill material during the addition to at least one capillary comprises, based on the total weight of the fill material, about 1 to about 20 weight percent crystalline sorbitol and/or xylitol, and about 80 to about 99 weight percent liquid sorbitol and xylitol.

3. The method of claim 2, wherein the fill material during the addition to at least one capillary comprises, based on the total weight of the fill material, about 5 to about 15 weight percent of the crystalline sorbitol and/or xylitol, and about 85 to about 95 weight percent liquid sorbitol and xylitol.

4. The method of claim 2, wherein the crystalline sorbitol and/or xylitol comprises, based on the total weight of crystalline sorbitol and/or xylitol, about 20 to about 40 weight percent crystalline sorbitol and about 60 to about 80 weight percent crystalline xylitol.

5. The method of claim 2, wherein the liquid sorbitol and xylitol comprises, based on the total weight of liquid sorbitol and xylitol, about 20 to about 40 weight percent sorbitol and about 60 to about 80 weight percent xylitol.

6. The method of claim 2, further comprising forming the fill material prior to said adding the fill material to at least one capillary; wherein said forming the fill material comprises blending about 1 to about 20 weight percent crystalline sorbitol and/or xylitol, and about 80 to about 99 weight percent liquid sorbitol and xylitol, based on the total weight of the fill material.

7. The method of claim 1, wherein said extruding a chewing gum material is simultaneous with said adding a fill material to at least one capillary.

8. The method of claim 1, wherein the fill material comprises less than or equal to 5 weight percent water, based on the total weight of fill material.

9. The method of claim 1, wherein the fill material comprises less than or equal to 0.1 weight percent thickening agent, based on the total weight of fill material.

10. The method of claim 1, wherein the fill material comprises the sorbitol and xylitol in a weight ratio of about 20:80 to about 40:60.

11. The method of claim 1, wherein the total of sorbitol and xylitol in the fill material is at least 90 weight percent, based on the total weight of the fill material.

12. The method of claim 1, wherein said extruding a chewing gum material comprises extruding the chewing gum material at a temperature of about 30 to about 50° C.

13. The method of claim 1, wherein said adding a fill material to at least one capillary comprises adding the fill material at a temperature of about 60 to about 80° C.

14. The method of claim 1, further comprising cooling the chewing gum product to harden the fill material.

15. The method of claim 1, further comprising crystallizing the fill material to form crystals having at least one dimension of at least 20 micrometers.

16. The method of claim 1, wherein the chewing gum product comprises about 60 to about 90 weight percent of the chewing gum material, and about 10 to about 40 weight percent of the fill material.

17. The method of claim 1, wherein said adding a fill material to at least one capillary comprises adding a fill material to a first capillary and adding a different fill material to a second capillary.

18. The method of claim 1,
wherein the fill material comprises less than or equal to 5 weight percent water, based on the total weight of fill material;
wherein the fill material comprises less than or equal to 0.05 weight percent thickening agent, based on the total weight of fill material;
wherein the fill material comprises the sorbitol and xylitol in a weight ratio of about 20:80 to about 40:60;
wherein the total of sorbitol and xylitol in the fill material is at least 90 weight percent;
wherein the adding a fill material to at least one capillary comprises adding the fill material at a temperature of about 60 to about 80° C.; and
wherein the chewing gum product comprises about 60 to about 90 weight percent of the chewing gum material, and about 10 to about 40 weight percent of the fill material.

19. The method of claim 18, wherein the fill material during the addition to at least one capillary comprises, based on the total weight of the fill material, about 1 to about 20 weight percent crystalline sorbitol and/or xylitol, and about 80 to about 99 weight percent liquid sorbitol and xylitol.

20. A chewing gum product prepared by the method of claim 1.

21. A chewing gum product, comprising:
an extruded body portion comprising a chewing gum material; and
a plurality of capillaries disposed in the extruded body portion, at least one of the capillaries comprising a fill material comprising, based on the total weight of the fill material, about 20 to about 80 weight percent sorbitol, and about 20 to about 80 weight percent xylitol;
wherein the total of sorbitol and xylitol is at least 80 weight percent, based on the total weight of the fill material.

22. The chewing gum product of claim 21, wherein the fill material comprises less than or equal to 5 weight percent water, based on the total weight of fill material.

23. The chewing gum product of claim 21, wherein the fill material comprises less than or equal to 0.1 weight percent thickening agent, based on the total weight of fill material.

24. The chewing gum product of claim 21, wherein the fill material comprises the sorbitol and xylitol in a weight ratio of about 20:80 to about 40:60.

25. The chewing gum product of claim 21, wherein the total of sorbitol and xylitol in the fill material is at least 90 weight percent, based on the total weight of the fill material.

26. The chewing gum product of claim 21, comprising about 60 to about 90 weight percent of the chewing gum material, and about 10 to about 40 weight percent of the fill material.

27. The chewing gum product of claim 21,
wherein the fill material comprises less than or equal to 5 weight percent water, based on the total weight of fill material;
wherein the fill material comprises less than or equal to 0.05 weight percent thickening agent, based on the total weight of fill material;
wherein the fill material comprises the sorbitol and xylitol in a weight ratio of about 20:80 to about 40:60;
wherein the total of sorbitol and xylitol in the fill material is at least 90 weight percent; and
wherein the chewing gum product comprises about 60 to about 90 weight percent of the chewing gum material, and about 10 to about 40 weight percent of the fill material.

28. The chewing gum product of claim 21, comprising a first capillary comprising a first fill material, and a second capillary comprising a second fill material different from the first fill material.
